(19) United States
(12) Patent Application Publication
(10) Pub. No.: US 2018/0290613 A1
(43) Pub. Date: Oct. 11, 2018

(54) IMPACT DETERMINATION METHOD, IMPACT DETERMINATION DEVICE, NON-TRANSITORY STORAGE MEDIUM ON WHICH IMPACT DETERMINATION PROGRAM IS RECORDED, IMPACT DATA EXTRACTION METHOD, IMPACT DATA EXTRACTION DEVICE, AND NON-TRANSITORY STORAGE MEDIUM ON WHICH IMPACT DATA EXTRACTION PROGRAM IS RECORDED

(71) Applicant: TOYOTA JIDOSHA KABUSHIKI KAISHA, Toyota-shi (JP)

(72) Inventor: Yosuke YAMAGUCHI, Toyota-shi (JP)

(73) Assignee: TOYOTA JIDOSHA KABUSHIKI KAISHA, Toyota-shi (JP)

(21) Appl. No.: 15/948,449

(22) Filed: Apr. 9, 2018

(30) Foreign Application Priority Data
Apr. 11, 2017 (JP) 2017-078289

(51) Int. Cl. B60R 21/0132; B60R 21/16

(52) U.S. Cl. CPC B60R 21/0132; B60R 2021/01231; B60R 21/16

(57) ABSTRACT

An impact determination method includes: acquiring, by an computer, a vehicle position; acquiring, by the computer, an acceleration of the vehicle; determining, by the computer, whether or not an impact is applied to the vehicle by determining the acceleration using a different threshold corresponding to the vehicle position; and outputting a signal representing a determination.

### INCORPORATION BY REFERENCE

The disclosure of Japanese Patent Application No. 2017-078289 filed on Apr. 11, 2017 including the specification, drawings and abstract is incorporated herein by reference in its entirety.

### BACKGROUND

### 1. Technical Field

The present disclosure relates to an impact determination method, an impact determination device, a non-transitory storage medium on which an impact determination program is recorded, an impact data extraction method, an impact data extraction device, and a non-transitory storage medium on which an impact data extraction program is recorded.

### 2. Description of Related Art

When a determination that a vehicle is traveling in a specific region is made based on the current position of the vehicle and map data, a device in the related art compares information of the size of the specific region with a threshold corresponding to the size. The device controls notification sounds of the vehicle when the information satisfies the threshold (for example, refer to WO 2011/104755).

### SUMMARY

When a vehicle is traveling in a specific region, a device in the related art uses a threshold corresponding to the size of the specific region, and does not set the specific region in accordance with the acceleration of the vehicle or set a threshold corresponding to the acceleration of the vehicle.

Thus, for example, in a case where the method of setting the threshold in the device in the related art is applied to a device that determines the degree of impact caused by a collision or the like of the vehicle, when the threshold is excessively low, the degree of impact when the vehicle passes over a bump or a pothole at a high speed exceeds the threshold, and an erroneous determination that a collision of the vehicle occurs may be made even though a collision of the vehicle does not occur. Conversely, in such a case, when the threshold is excessively high, the degree of impact when a collision of the vehicle occurs at a low speed does not exceed the threshold, and an erroneous determination that a collision of the vehicle does not occur may be made even though a collision of the vehicle occurs.

Accordingly, erroneous determinations may be made when the method of setting the threshold in the device in the related art is applied to the device that determines the degree of impact caused by a collision or the like of the vehicle.

The present disclosure provides an impact determination method, an impact determination device, a non-transitory storage medium on which an impact determination program is recorded, an impact data extraction method, an impact data extraction device, and a non-transitory storage medium on which an impact data extraction program is recorded that can correctly determine an event accompanying an impact in accordance with the position of a vehicle and the acceleration of the vehicle.

A first aspect of the present disclosure relates to an impact determination method including: acquiring, by an computer, a vehicle position; acquiring, by the computer, an acceleration of the vehicle; determining, by the computer, whether or not an impact is applied to the vehicle by determining the acceleration using a different threshold corresponding to the vehicle position; and outputting a signal representing a determination..

Thus, it is possible to determine whether or not the impact is applied to the vehicle by determining the acceleration using the different threshold corresponding to the vehicle position.

Accordingly, it is possible to provide the impact determination method that can correctly determine an event accompanying an impact in accordance with the position of the vehicle and the acceleration of the vehicle.

The impact determination method according to the first aspect of the present disclosure may further include determining, by the computer, whether the vehicle position is a first position or a second position, wherein the determining whether or not an impact is applied to the vehicle may include determining, by the computer, whether or not the impact is applied to the vehicle by comparing the acceleration with a first determination threshold when a determination that the vehicle position is the first position is made, and determining, by the computer, whether or not the impact is applied to the vehicle by comparing the acceleration with a second determination threshold higher than the first determination threshold when a determination that the vehicle position is the second position is made.

Thus, a determination as to whether or not the impact is applied with different levels of impact at the first position and the second position can be performed.

Accordingly, it is possible to provide the impact determination method that can correctly determine an event accompanying an impact with different levels of impact at the first position and the second position in accordance with the position of the vehicle and the acceleration of the vehicle.

The impact determination method according to the first aspect of the present disclosure may further include executing, by the computer, when a determination that the impact is applied to the vehicle is made, a control to deploy an airbag.

Thus, the control for deploying the airbag can be executed after a determination as to whether or not the impact is applied with different levels of impact at the first position and the second position is performed.

Accordingly, it is possible to provide the impact determination method that can execute the control to deploy the airbag after correctly determining an event accompanying an impact with different levels of impact at the first position and the second position in accordance with the position of the vehicle and the acceleration of the vehicle.

The impact determination method according to the first aspect of the present disclosure may further include executing, by the computer, when a determination that the impact is applied to the vehicle is made, a control to record vehicle information including the vehicle position.

Thus, the vehicle position and the acceleration can be retained as data after a determination as to whether or not the impact is applied with different levels of impact at the first position and the second position is performed.

Accordingly, it is possible to provide the impact determination method that correctly determines an event accompanying an impact in accordance with the position of the vehicle and the acceleration of the vehicle, and retains the vehicle position and the acceleration as data for different levels of impact at the first position and the second position.

In the impact determination method according to the first aspect of the present disclosure, the first position may be a position where a speed limit of the vehicle is lower than the speed limit of the vehicle at the second position.

Thus, it is possible to separately determine whether or not a light impact that may be applied at a position where the speed limit is relatively low is applied, and whether or not a heavy impact that may be applied at a position where the speed limit is relatively high is applied, using different determination thresholds.

Accordingly, it is possible to provide the impact determination method that can correctly determine an event accompanying an impact in accordance with the position of the vehicle and the acceleration of the vehicle.

A second aspect of the present disclosure relates to an impact determination device including an electronic control unit configured to: acquire a vehicle position that is a position of a vehicle; acquire an acceleration of the vehicle; determine whether or not an impact is applied to the vehicle by determining the acceleration using a different threshold corresponding to the vehicle position; and output a signal representing a determination.

Thus, it is possible to determine whether or not the impact is applied to the vehicle by determining the acceleration using the different threshold corresponding to the vehicle position.

Accordingly, it is possible to provide the impact determination device that can correctly determine an event accompanying an impact in accordance with the position of the vehicle and the acceleration of the vehicle.

In the impact determination device according to the second aspect of the present disclosure, the electronic control unit may be configured to: determine whether the vehicle position is a first position or a second position; determine, when the electronic control unit determines that the vehicle position is the first position, whether or not the impact is applied to the vehicle by comparing the acceleration with a first determination threshold; and determine, when the electronic control unit determines that the vehicle position is the second position, whether or not the impact is applied to the vehicle by comparing the acceleration with a second determination threshold higher than the first determination threshold.

In the impact determination device according to the second aspect of the present disclosure, the electronic control unit may be configured to output a signal to execute a control to deploy an airbag when the electronic control unit determines that the impact is applied to the vehicle.

In the impact determination device according to the second aspect of the present disclosure, the electronic control unit may be configured to output a signal to execute a control to record vehicle information including the vehicle position when the electronic control unit determines that the impact is applied to the vehicle.

In the impact determination device according to the second aspect of the present disclosure, the first position may be a position where a speed limit of the vehicle is lower than the speed limit of the vehicle at the second position.

A third aspect of the present disclosure relates to a non-transitory storage medium on which an impact determination program is recorded. The impact determination program causes an impact determination device to execute acquiring a vehicle position that is a position of the vehicle, acquiring an acceleration of the vehicle, determining whether or not an impact is applied to the vehicle by determining the acceleration using a different threshold corresponding to the vehicle position, and outputting a signal representing a determination.

Thus, it is possible to determine whether or not the impact is applied to the vehicle by determining the acceleration using the different threshold corresponding to the vehicle position.

Accordingly, it is possible to provide the non-transitory storage medium on which the impact determination program that can correctly determine an event accompanying an impact in accordance with the position of the vehicle and the acceleration of the vehicle is recorded.

A fourth aspect of the present disclosure relates to an impact data extraction method. The impact data extraction method includes, acquiring, by an computer, a time, a vehicle position, and an acceleration associated with each other from a database storing the time, a vehicle position that is a position of the vehicle at the time, and the acceleration of the vehicle in the vehicle position in association with each other, determining, by the computer, whether or not the impact is applied to the vehicle by determining the acceleration using a different threshold corresponding to the vehicle position, and extracting, by the computer, the acceleration at a time when a determination that the impact is applied to the vehicle is made in the determining of the impact, and the vehicle position and the time associated with the acceleration from the database.

Thus, it is possible to determine whether or not the impact is applied to the vehicle by determining the acceleration using the different threshold corresponding to the vehicle position.

Accordingly, it is possible to provide the impact data extraction method that can correctly determine an event accompanying an impact in accordance with the position of the vehicle and the acceleration of the vehicle.

The impact data extraction method according to the fourth aspect of the present disclosure may further include determining, by the computer, whether the vehicle position is a first position or a second position. The determining whether or not an impact is applied to the vehicle may include determining, by the computer, whether or not the impact is applied to the vehicle by comparing the acceleration with a first determination threshold when a determination that the vehicle position is the first position is made. The determining whether or not an impact is applied to the vehicle may include determining, by the computer, whether or not the impact is applied to the vehicle by comparing the acceleration with a second determination threshold higher than the first determination threshold when a determination that the vehicle position is the second position is made.

The impact data extraction method according to the fourth aspect of the present disclosure may further includes executing, by the computer, when a determination that the impact is applied to the vehicle is made a control to deploy an airbag.

The impact determination method according to the fourth aspect of the present disclosure may further includes executing, by the computer, when a determination that the impact is applied to the vehicle is made a control to record vehicle information including the vehicle position.

In the impact determination device according to the fourth aspect of the present disclosure, the first position may be a position where a speed limit of the vehicle is lower than the speed limit of the vehicle at the second position.

A fifth aspect of the present disclosure relates to an impact data extraction device including: a database storing a time, a vehicle position that is a position of the vehicle at the time, and an acceleration of the vehicle in the vehicle position in association with each other; and an electronic control unit configured to: acquire the time, the vehicle position, and the acceleration associated with each other from the database, determine whether or not an impact is applied to the vehicle by determining the acceleration using a different threshold corresponding to the vehicle position, and extract and output the acceleration at a time when the electronic control unit determines that the impact is applied to the vehicle, and the vehicle position and the time associated with the acceleration from the database.

Thus, it is possible to determine whether or not the impact is applied to the vehicle by determining the acceleration using the different threshold corresponding to the vehicle position.

Accordingly, it is possible to provide the impact data extraction device that can correctly determine an event accompanying an impact in accordance with the position of the vehicle and the acceleration of the vehicle.

In the impact data extraction device according to the fifth aspect of the present disclosure, the electronic control unit may be configured to: determine whether the vehicle position is a first position or a second position; determine, when the position determination unit determines that the vehicle position is the first position, whether or not the impact is applied to the vehicle by comparing the acceleration with a first determination threshold; and determine, when the position determination unit determines that the vehicle position is the second position, whether or not the impact is applied to the vehicle by comparing the acceleration with a second determination threshold higher than the first determination threshold.

In the impact data extraction device according to the fifth aspect of the present disclosure, the electronic control unit may be configured to output a signal to execute a control to deploy an airbag when the electronic control unit determines that the impact is applied to the vehicle.

In the impact determination device according to the fifth aspect of the present disclosure, the electronic control unit is configured to output a signal to execute a control to record vehicle information including the vehicle position when the impact determination unit determines that the impact is applied to the vehicle.

In the impact determination device according to the fifth aspect of the present disclosure, the first position may be a position where a speed limit of the vehicle is lower than the speed limit of the vehicle at the second position.

A sixth aspect of the present disclosure relates to a non-transitory storage medium on which an impact data extraction program is recorded. The impact data extraction program causes a computer to extract data representing whether or not an impact is applied to a vehicle. The impact data extraction program causes the computer to execute acquiring a time, a vehicle position, and an acceleration associated with each other from a database storing the time, the vehicle position that is a position of the vehicle at the time, and the acceleration of the vehicle in the vehicle position in association with each other, determining whether or not the impact is applied to the vehicle by determining the acceleration using a different threshold corresponding to the vehicle position acquired in the acquiring, and extracting and outputting the acceleration at a time when a determination that the impact is applied to the vehicle is made in the determining of the impact, and the vehicle position and the time associated with the acceleration from the database.

Thus, it is possible to determine whether or not the impact is applied to the vehicle by determining the acceleration using the different threshold corresponding to the vehicle position.

Accordingly, it is possible to provide the non-transitory storage medium on which the impact data extraction program that can correctly determine an event accompanying an impact in accordance with the position of the vehicle and the acceleration of the vehicle is recorded.

According to the aspects of the present disclosure, it is possible to provide the impact determination method, the impact determination device, the non-transitory storage medium including the impact determination program recorded thereon, the impact data extraction method, the impact data extraction device, and the non-transitory storage medium including the impact data extraction program recorded thereon that can correctly determine an event accompanying an impact in accordance with the position of the vehicle and the acceleration of the vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of a vehicle that includes an impact determination device of a first embodiment;

FIG. 2 is a diagram illustrating data used in impact determination;

FIG. 3 is a diagram illustrating categorization of position;

FIG. 4A is a graph illustrating a threshold used in impact determination;

FIG. 4B is a graph illustrating a threshold used in impact determination;

FIG. 5 is a flowchart illustrating a process executed by an airbag ECU;

FIG. 6 is a diagram illustrating an impact data extraction device of a second embodiment;

FIG. 7 is a diagram illustrating data stored in a DB;

FIG. 8 is a flowchart illustrating a process executed by the impact data extraction device; and

FIG. 9 is a diagram illustrating light impact and heavy impact data extracted using the flow illustrated in FIG. 8.

### DETAILED DESCRIPTION OF EMBODIMENTS

Hereinafter, embodiments to which an impact determination method, an impact determination device, a non-transitory storage medium including an impact determination program recorded thereon, an impact data extraction method, an impact data extraction device, and a non-transitory storage medium including an impact data extraction program recorded thereon of the present disclosure are applied will be described.

### First Embodiment

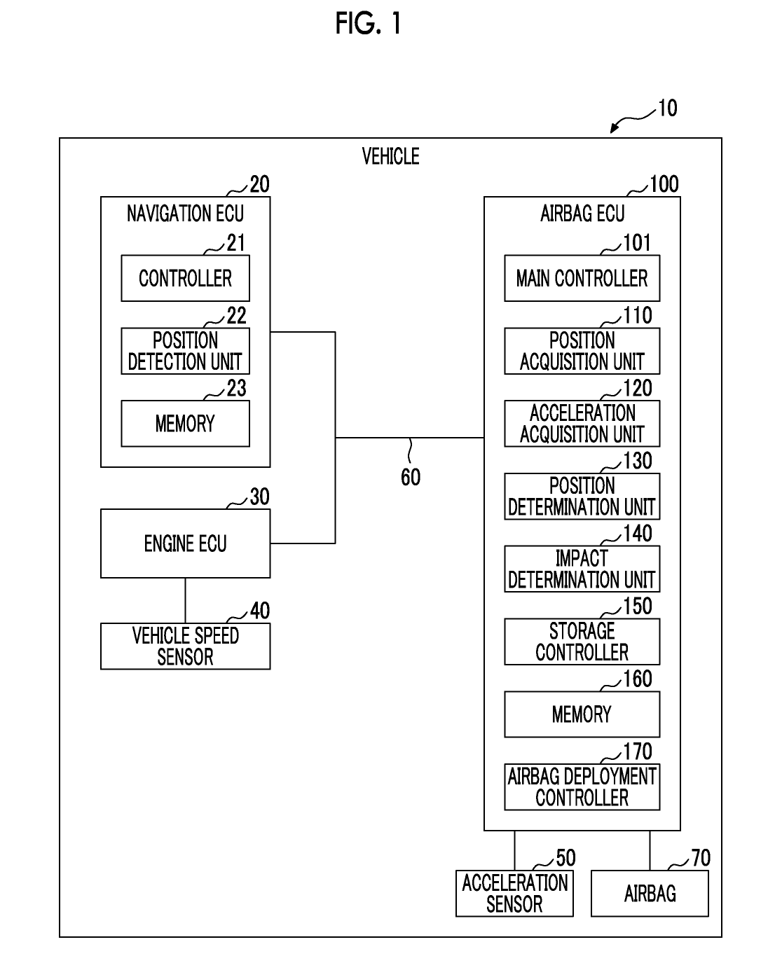

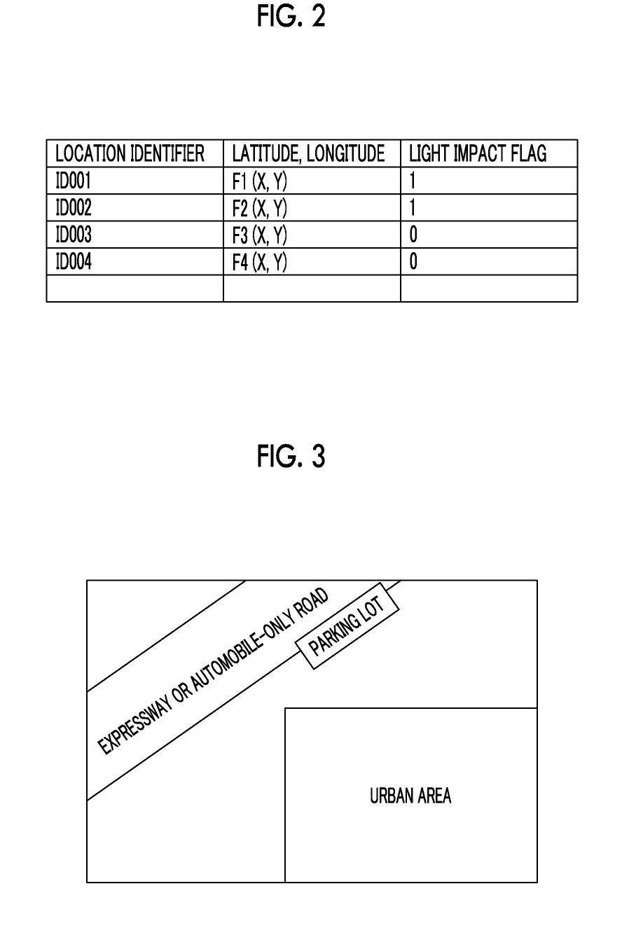

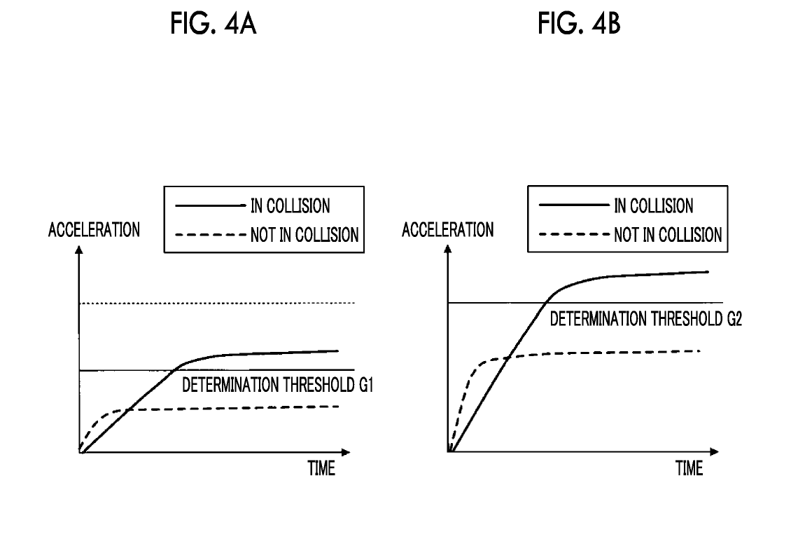

FIG. 1 is a diagram illustrating a configuration of a vehicle 10 that includes an impact determination device of a first embodiment. FIG. 2 is a diagram illustrating data used in impact determination. FIG. 3 is a diagram illustrating categorization of position. FIG. 4A and FIG. 4B are graphs illustrating a threshold used in impact determination.

A navigation electronic control unit (ECU) 20, an engine ECU 30, a vehicle speed sensor 40, an acceleration sensor 50, a controller area network (CAN) 60, an airbag 70, and an airbag ECU 100 are mounted in the vehicle 10. The impact determination device of the first embodiment is mounted in the vehicle 10 as the airbag ECU 100. Other ECUs, sensors, and the like mounted in the vehicle 10 will not be described here.

The vehicle 10 is a vehicle in which an engine (internal combustion engine) that uses gasoline, diesel, or the like as fuel is mounted. For example, the vehicle 10 may be a vehicle that performs autonomous driving at any level of level 1 to level 5 defined by Society of Automotive Engineers (SAE), or may be a vehicle that does not perform autonomous driving. Here, the vehicle 10 is illustratively described as using an engine as a power source. However, when the vehicle 10 is a hybrid vehicle (HV) or an electric vehicle (EV), an HV-ECU that controls the output of the engine or a drive motor, or an EV-ECU that controls the output of the drive motor may be used instead of the engine ECU 30.

The navigation ECU 20 includes a controller 21, a position detection unit 22, and a memory 23. For example, the navigation ECU 20 is an ECU that is disposed inside a navigation system mounted in the vehicle 10 to control the navigation system.

The navigation ECU 20 is a computer that includes a central processing unit (CPU), a random access memory (RAM), a read-only memory (ROM), a hard disk drive (HDD), and the like. The controller 21 and the position detection unit 22 are function blocks that represent the function of a program executed by the navigation ECU 20.

The navigation ECU 20 is connected to the engine ECU 30, the airbag ECU 100, and other ECUs through the CAN 60.

For example, the controller 21 performs a process of displaying map data stored in the memory 23 on a display, a process of displaying the current position of the vehicle detected by the position detection unit 22 on the map displayed on the display, and a process of performing route search, route guidance, and the like.

The position detection unit 22 is connected to a global positioning system (GPS) antenna and acquires position data and time data from a GPS signal. The position data acquired by the position detection unit 22 is data that represents the current position (latitude and longitude) of the vehicle 10. The time data is data that represents the current time. The position data and the time data are used in the processes performed by the controller 21 and are also output to the CAN 60.

The memory 23 is a ROM or an HDD represented as a memory and stores data of the map (map data) and the like displayed on the display of the navigation system.

The engine ECU 30 is an ECU that controls the operation of the engine of the vehicle 10. The engine ECU 30 is a computer that includes a CPU, a RAM, a ROM, and the like. The vehicle speed sensor 40 is connected to the engine ECU 30. The engine ECU 30 is connected to the navigation ECU 20, the airbag ECU 100, and other ECUs through the CAN 60.

The vehicle speed sensor 40 is a sensor that detects the speed of the vehicle 10. For example, the vehicle speed sensor 40 converts the number of rotations of an axle into a vehicle speed and outputs the vehicle speed. The vehicle speed sensor 40 outputs data representing the vehicle speed to the engine ECU 30. The data representing the vehicle speed is used by the engine ECU 30 in control of the engine and is also output to the CAN 60. The data representing the vehicle speed is transferred to the airbag ECU 100 through the CAN 60.

The acceleration sensor 50 is a sensor that detects acceleration generated in the vehicle 10. For example, a microelectromechanical systems (MEMS) sensor can be used as the acceleration sensor 50. The acceleration sensor 50 is connected to the airbag ECU 100 and inputs acceleration data representing the acceleration generated in the vehicle 10 into the airbag ECU 100. The acceleration generated in the vehicle 10 is one example of the acceleration of the vehicle.

The controller area network (CAN) 60 is a bus that connects the engine ECU 30, the navigation ECU 20, the airbag ECU 100, and other ECUs to each other and constitutes a vehicle-mounted network through which data communication can be performed. While the CAN 60 that uses CAN protocol is described here, a bus other than a CAN such as a bus employing Ethernet (registered trademark) protocol may be used instead of the CAN 60.

The airbag 70 is disposed in a steering wheel, a seat, a dashboard in front of a passenger seat, or the like in the vehicle 10. The airbag 70 is deployed by the airbag ECU 100 in order to protect the occupants when the vehicle 10 collides with another vehicle or the like.

The airbag ECU 100 includes a main controller 101, a position acquisition unit 110, an acceleration acquisition unit 120, a position determination unit 130, an impact determination unit 140, a storage controller 150, a memory 160, and an airbag deployment controller 170. The airbag ECU 100 is a computer that includes a CPU, a RAM, a ROM, and the like. The main controller 101, the position acquisition unit 110, the acceleration acquisition unit 120, the position determination unit 130, and the impact determination unit 140 are function blocks that represent the function of a program executed by the airbag ECU 100. Here, except for the airbag deployment controller 170, the main controller 101, the position acquisition unit 110, the acceleration acquisition unit 120, the position determination unit 130, the impact determination unit 140, the storage controller 150, and the memory 160 of the airbag ECU 100 may be regarded as a data recording ECU.

While the impact determination device of the first embodiment is described as the airbag ECU 100 mounted in the vehicle 10, the part of the airbag ECU 100 except for the storage controller 150 and the memory 160 may be regarded as the impact determination device.

The airbag ECU 100 is connected to the navigation ECU 20, the engine ECU 30, and other ECUs through the CAN 60. The acceleration sensor 50 is connected to the airbag ECU 100.

The airbag ECU 100 performs a predetermined control process using the acceleration data input from the acceleration sensor 50, and records data related to a collision or the like. The airbag ECU 100 may output the acceleration data to the CAN 60.

The main controller 101 is a controller that controls processes executed by the position acquisition unit 110, the acceleration acquisition unit 120, the position determination unit 130, and the impact determination unit 140. The main controller 101 performs processes other than the processes executed by the position acquisition unit 110, the acceleration acquisition unit 120, the position determination unit 130, and the impact determination unit 140.

The position acquisition unit 110 acquires the position data through the CAN 60. The acceleration acquisition unit 120 acquires the acceleration data from the acceleration sensor 50.

The position determination unit 130 determines whether the position data acquired by the position acquisition unit 110 represents a position where a light impact may be applied, or a position where a heavy impact may be applied. The position where a light impact may be applied is one example of a first position. The position where a heavy impact may be applied is one example of a second position.

When the position data represents the position where a light impact may be applied, the impact determination unit 140 determines whether or not a light impact is applied in the vehicle 10 by comparing the acceleration represented by the acceleration data acquired by the acceleration acquisition unit 120 with a determination threshold used in determination of a light impact. The determination threshold used in determination of a light impact is one example of a first determination threshold.

When the position data represents the position where a heavy impact may be applied, the impact determination unit 140 determines whether or not a heavy impact is applied in the vehicle 10 by comparing the acceleration represented by the acceleration data acquired by the acceleration acquisition unit 120 with a determination threshold used in determination of a heavy impact. The determination threshold used in determination of a heavy impact is one example of a second determination threshold. The second determination threshold is higher than the first determination threshold.

Here, the impact is an impact that the vehicle 10 receives, and is represented as the rate of change in speed (acceleration) generated in the vehicle 10. The impact is detected as an acceleration by the acceleration sensor 50.

The light impact is an impact at or above the predetermined determination threshold used in determination of the light impact among relatively light impacts that have a degree of impact lower than or equal to a predetermined degree. For example, the light impact is an impact at or above the predetermined determination threshold used in determination of the light impact among impacts that are applied in the vehicle 10 when the position (location) where the vehicle 10 is traveling is a location such as a road in an urban area or a parking lot where the speed limit is relatively low. The determination threshold used in determination of such a light impact is one example of the first determination threshold. The location (position) where the speed limit is relatively low is one example of the first position. For example, the relatively low speed limit is lower than or equal to 60 km/h.

The predetermined degree is an acceleration that enables separation between such a light impact and a heavy impact that is greater (stronger) than the light impact.

The light impact is assumed to be an impact that the vehicle 10 receives by contact or collision of the vehicle 10 with another vehicle, an obstacle, or the like when the position (location) where the vehicle 10 is traveling is the location (first position) where the speed limit is relatively low. The light impact does not include an impact that are applied when the vehicle 10 passes over a rough road surface such as a bump or a pothole.

Thus, the impact determination unit 140 determines whether or not the light impact is applied using the determination threshold used in determination of the light impact when the position (location) where the vehicle 10 is traveling is the location (first position) where the speed limit is relatively low.

When the position data represents the location (first position) where the speed limit is relatively low, the impact determination unit 140 determines that the light impact is applied in the vehicle 10 when the impact is at or above the determination threshold used in determination of the light impact. The impact determination unit 140 determines that the light impact is not applied in the vehicle 10 when the impact is below the predetermined threshold.

The heavy impact is an impact at or above the predetermined determination threshold used in determination of the heavy impact among impacts having a degree of impact higher than the light impact. For example, the heavy impact is an impact at or above the predetermined determination threshold used in determination of the heavy impact among impacts that are applied in the vehicle 10 when the position (location) where the vehicle 10 is traveling is a location such as an expressway or an automobile-only road where the speed limit is relatively high. The determination threshold used in determination of such a heavy impact is one example of the second determination threshold. The location (position) where the speed limit is relatively high is one example of the second position. For example, the relatively high speed limit is a speed higher than 60 km/h. For example, the relatively high speed limit corresponds to a speed limit such as 70 km/h, 80 km/h, and 100 km/h.

The heavy impact is assumed to be an impact that the vehicle 10 receives by contact or collision of the vehicle 10 with another vehicle, an obstacle, or the like when the position (location) where the vehicle 10 is traveling is the location (second position) where the speed limit is relatively high. The heavy impact does not include an impact that is applied when the vehicle 10 passes over a rough road surface such as a bump or a pothole.

Thus, the impact determination unit 140 determines whether or not the heavy impact is applied using the determination threshold used in determination of the heavy impact when the position (location) where the vehicle 10 is traveling is the location (second position) where the speed limit is relatively high.

When the position data represents the location (second position) where the speed limit is relatively high, the impact determination unit 140 determines that the heavy impact is applied in the vehicle 10 when the impact is at or above the determination threshold used in determination of the heavy impact. The impact determination unit 140 determines that the heavy impact is applied in the vehicle 10 when the impact is below the predetermined threshold.

When the impact determination unit 140 determines that the light impact or the heavy impact is applied, the storage controller 150 writes (stores) the time data representing the time of application of the light impact or the heavy impact, the position data representing the position of application of the light impact or the heavy impact, and the acceleration data at the application of the light impact or the heavy impact in association with each other into an impact database stored in the memory 160. Accordingly, storing the time data, the position data, and the acceleration data at the application of the light impact or the heavy impact in the impact database means recording data related to the light impact or the heavy impact. Thus, the impact determination device is referred to as the airbag ECU 100.

The memory 160 stores an impact determination program that causes a computer to function as the airbag ECU 100. The memory 160 is a non-transitory storage medium storing data such as a program that can be read by a computer. The memory 160 is implemented using a non-volatile memory. The memory 160 stores data used in impact determination illustrated in FIG. 2, data representing thresholds used in impact determination illustrated in FIG. 4A and FIG. 4B, and the impact database.

The airbag deployment controller 170 performs a control to deploy the airbag 70 when the impact determination unit 140 determines that the light impact or the heavy impact is applied.

The data used in impact determination illustrated in FIG. 2 is data that includes a location identifier, the latitude and the longitude, and a light impact flag in association with each other. FIG. 3 illustrates the map represented by the map data. For example, as illustrated in the map in FIG. 3, locations where the vehicle 10 may be positioned include an expressway or an automobile-only road, a parking lot, an urban area, and the like. The urban area is a land or a district where houses, commercial facilities, stores, and shopping streets are densely located. While the position such as an expressway or an automobile-only road where the speed limit is relatively high may be present in the urban area, the urban area referred hereto does not include the position where the speed limit is relatively high in the urban area.

The data illustrated in FIG. 2 is table-format data that includes the location identifier, data representing the latitude and the longitude, and the light impact flag in association with each other. For example, a location identifier ID001 is an identifier of an urban area A. A location identifier ID002 is an identifier of a parking lot B. A location identifier ID003 is an identifier of an expressway C. A location identifier ID004 is an identifier of an automobile-only road D.

Here, the urban area A, the parking lot B, the expressway C, and the automobile-only road D are the names of an existing urban area, parking lot, expressway, and automobile-only road respectively. Accordingly, unique identifiers (ID) are assigned to various existing locations such as an urban area, a parking lot, an expressway, and an automobile-only road.

The data representing the latitude and the longitude represents the latitude and the longitude of each of the urban area A, the parking lot B, the expressway C, and the automobile-only road D. For example, a location such as an urban area, an expressway, and an automobile-only road that can be specified with a link or a node in the map data may be specified with the latitude and the longitude of the link or the node included in the location. For example, the latitudes and the longitudes of the links or the nodes included in the urban area A, the expressway C, and the automobile-only road D are represented by F1(X,Y), F3(X,Y), and F4(X,Y) respectively. A location that is represented as a point of interest (POI) in the map data like a parking lot and various stores or facilities may be specified with the latitude and the longitude of the POI. For example, the latitude and the longitude of the parking lot B are represented by F2(X,Y).

Each of the urban area A, the parking lot B, the expressway C, and the automobile-only road D is associated with the light impact flag. When the light impact flag is equal to “1”, the light impact flag represents a position where the light impact may be applied. When the light impact flag is equal to “0”, the light impact flag represents a position where the heavy impact may be applied. The light impact flags of the urban area A, the parking lot B, the expressway C, and the automobile-only road D are set to “1”, “1”, “0”, and “0” respectively.

As illustrated in FIG. 2, the airbag ECU 100 uses, in impact determination, the data in which the light impact flag is set to “1” at the position (an urban area, a parking lot, or the like) where the light impact may be applied, and is set to “0” at the position (an expressway, an automobile-only road, or the like) where the heavy impact may be applied.

While the light impact may be applied at the position where the speed limit is relatively low, the heavy impact may be applied at the position where the speed limit is relatively high. Thus, the determination threshold used in determination of the light impact is a value that is lower than the determination threshold used in determination of the heavy impact.

In FIG. 4A and FIG. 4B, the horizontal axis denotes an elapsed time period from the application of the impact, and the vertical axis denotes the acceleration at the time of impact. For example, a determination threshold G1 that is used in determination of the light impact is set as illustrated in FIG. 4A. The determination threshold G1 is lower than a determination threshold G2 that is used in determination of the heavy impact illustrated in FIG. 4B.

When the vehicle 10 is at the position where the light impact may be applied, and an impact not caused by a collision is applied, the acceleration at the time of impact is lower than the determination threshold G1 and does not reach the determination threshold G1 as illustrated by a broken line. When the vehicle 10 is at the position where the light impact may be applied, and an impact caused by a collision is applied, the acceleration at the time of impact exceeds the determination threshold G1 as illustrated by a solid line. Accordingly, the impact determination unit 140 may determine whether or not the impact is a light impact using the determination threshold G1 when the vehicle 10 is at the position where the light impact may be applied.

When the vehicle 10 is at the position where the heavy impact may be applied, and an impact not caused by a collision is applied, the acceleration at the time of impact is lower than the determination threshold G2 and does not reach the determination threshold G2 as illustrated by a broken line. When the vehicle 10 is at the position where the heavy impact may be applied, and an impact caused by a collision is applied, the acceleration at the time of impact exceeds the determination threshold G2 as illustrated by a solid line. Accordingly, the impact determination unit 140 may determine whether or not the impact is a heavy impact using the determination threshold G2 when the vehicle 10 is at the position where the heavy impact may be applied.

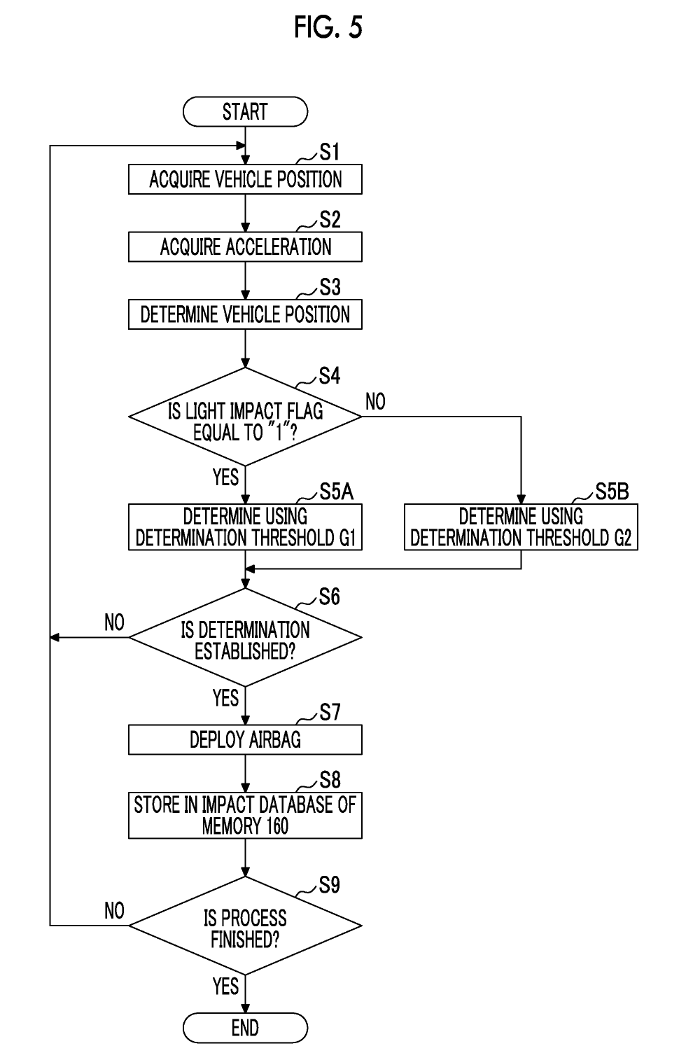

FIG. 5 is a flowchart illustrating a process executed by the airbag ECU 100. The flow illustrated in FIG. 5 represents a data recording method. Such a method is realized by the airbag ECU 100 executing a data recording program. The data recording method and the data recording program include the impact determination method and the impact determination program corresponding to the impact determination device. The impact determination method and the impact determination program correspond to the part of step 51 to step S6 in the data recording method and the data recording program.

The flow illustrated in FIG. 5 is started when an ignition switch of the vehicle 10 is set to an ON state.

The position acquisition unit 110 acquires the position data through the CAN 60 (step 51). Accordingly, the position data representing the current position of the vehicle 10 is acquired.

The acceleration acquisition unit 120 acquires the acceleration data from the acceleration sensor 50 (step S2). Accordingly, the acceleration data representing the current acceleration of the vehicle 10 is acquired.

The position determination unit 130 determines whether the position data acquired in step 51 represents the position (an urban area, a parking lot, or the like) where the light impact may be applied, or the position (an expressway, an automobile-only road, or the like) where the heavy impact may be applied (step S3). The determination in step S3 is a process of specifying the current position of the vehicle 10 by determining the latitude and the longitude of any of the location identifiers ID001 to ID004 in the data illustrated in FIG. 2 that include the position data acquired in step 51.

The impact determination unit 140 reads the light impact flag associated with the position specified in step S3 from the data in FIG. 2, and determines whether or not the light impact flag is equal to “1” (step S4).

When the impact determination unit 140 determines that the light impact flag is equal to “1” (S4: YES), the impact determination unit 140 uses the determination threshold G1 to determine whether or not the acceleration data acquired by the acceleration acquisition unit 120 is higher than or equal to the determination threshold G1 (step S5A).

When the impact determination unit 140 determines that the light impact flag is equal to “0” (S4: NO), the impact determination unit 140 uses the determination threshold G2 to determine whether or not the acceleration data acquired by the acceleration acquisition unit 120 is higher than or equal to the determination threshold G2 (step S5B).

When the process of step S5A or S5B is finished, the impact determination unit 140 determines whether or not the determination in step S5A or S5B is established (step S6).

When the impact determination unit 140 determines that the determination is established (S6: YES), the airbag deployment controller 170 deploys the airbag 70 (step S7). The time data, the position data, and the acceleration data at the establishment of the determination are stored in the impact database of the memory 160 by the storage controller 150 (step S8). Accordingly, the time data, the position data, and the acceleration data at the application of the light impact can be stored in the impact database of the memory 160. The time data, the position data, and the acceleration data at the application of the heavy impact can be stored in the impact database of the memory 160. The impact database may include divided memory regions so that the data of the light impact and the data of the heavy impact can be separately stored.

When the impact determination unit 140 determines that the determination is not established (S6: NO), the main controller 101 causes the flow to return to step 51. The flow illustrated in FIG. 5 is repeated per predetermined control cycle (for example, 0.05 seconds). When the light impact or the heavy impact is applied, a time period corresponding to a plurality of control cycles may be taken before the acceleration of the vehicle 10 becomes higher than or equal to the determination threshold G1 or G2 from the time when the acceleration of the vehicle 10 starts to increase. In such a case, the processes of step 51 to step S6 are repeated in the time period corresponding to the cycles. When the acceleration of the vehicle 10 becomes higher than or equal to the determination threshold G1 or G2, the impact determination unit 140 in step S6 determines that the determination is established (S6: YES).

When the process of step S8 is finished, the main controller 101 determines whether or not the process is finished (step S9). For example, the process is finished when the ignition switch of the vehicle 10 is set to an OFF state. Then, the series of processes is finished.

As described thus far, the airbag ECU 100 of the first embodiment determines whether or not the light impact or the heavy impact is applied using the different determination threshold G1 or G2 according to whether the position of the vehicle 10 is the position where the light impact may be applied, or the position where the heavy impact may be applied.

Thus, when the vehicle 10 is at the position where the light impact may be applied, it is possible to determine whether or not the light impact is applied using the determination threshold G1 for the light impact. When the vehicle 10 is at the position where the heavy impact may be applied, it is possible to determine whether or not the heavy impact be applied using the determination threshold G2 for the heavy impact.

Accordingly, it is possible to provide the impact determination method, the impact determination device, and the non-transitory storage medium including the impact determination program recorded thereon that suppress erroneous determinations and can correctly determine an event accompanying an impact in accordance with the position of the vehicle 10 and the acceleration of the vehicle 10.

After the event accompanying the impact is correctly determined, the time data, the position data, and the acceleration data at the application of the light impact, and the time data, the position data, and the acceleration data at the application of the heavy impact can be stored in the database of the memory 160.

Thus, a situation where the time data, the position data, and the acceleration data when an impact other than from a collision of the vehicle is applied are erroneously stored in the database of the memory 160 can be suppressed, and the capacity of the memory 160 can be efficiently used. The time data, the position data, and the acceleration data at the time of collision can be recorded in the memory 160 having a smaller size. Thus, the size of the memory 160 can be reduced.

### Second Embodiment

An impact data extraction method, an impact data extraction device, and a non-transitory storage medium including an impact data extraction program recorded thereon that extract data related to the light impact and the heavy impact from a large amount of data such as big data storing the time data, the position data, and the acceleration data for various vehicles will be described in a second embodiment.

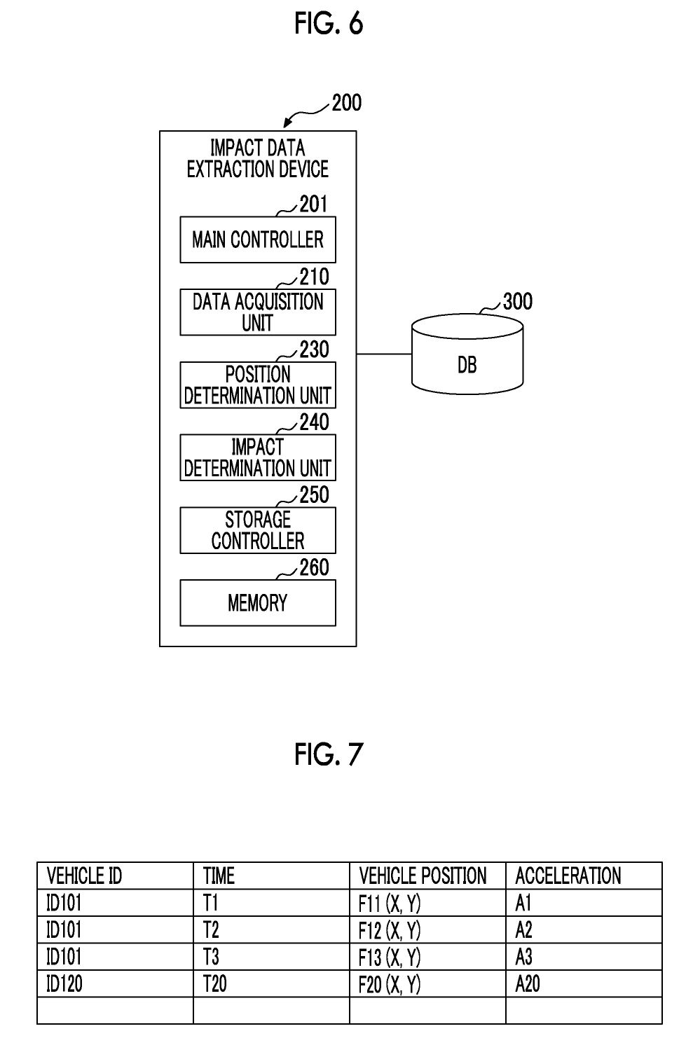

FIG. 6 is a diagram illustrating an impact data extraction device 200 of the second embodiment. FIG. 7 is a diagram illustrating data stored in a DB 300.

The impact data extraction device 200 includes a main controller 201, a data acquisition unit 210, a position determination unit 230, an impact determination unit 240, a storage controller 250, and a memory 260. The impact data extraction device 200 is a computer that includes a CPU, a RAM, a ROM, and the like. The main controller 201, the data acquisition unit 210, the position determination unit 230, and the impact determination unit 240 are function blocks that represent the function of a program executed by the impact data extraction device 200.

The database (DB) 300 is connected to the impact data extraction device 200. As illustrated in FIG. 7, the DB 300 stores data that includes a vehicle ID, a time during traveling, a vehicle position at the time, and the acceleration of the vehicle in the vehicle position in association with each other for various vehicles.

As illustrated in FIG. 7, a vehicle having a vehicle ID of ID101 is associated with time T1 in traveling, a vehicle position F11(X,Y), and an acceleration A1. The vehicle having the vehicle ID of ID101 is also associated with time T2 in traveling, a vehicle position F12(X,Y), and an acceleration A2, and is also associated with time T3 in traveling, a vehicle position F13(X,Y), and an acceleration A3. Times T1, T2, T3 in traveling are continuous, and the vehicle positions F11(X,Y), F12(X,Y), F13(X,Y) and the accelerations A1, A2, A3 represent changes in vehicle position and acceleration during continuous times T1, T2, T3.

A vehicle having a vehicle ID of ID120 is associated with time T20 in traveling, a vehicle position F20(X,Y), and an acceleration A20. In the vehicle position, X and Y denote latitude and longitude, respectively.

As described above, the data stored in the DB 300 for various vehicles is a collection of random traveling data for various vehicles, and is data in which a time during traveling, a vehicle position, and an acceleration are associated with a unique vehicle ID per vehicle. Such data also includes traveling data other than the light impact and the heavy impact. Such data is so-called big data.

The impact data extraction device 200 reads the data stored in the DB 300 and extracts traveling data related to the light impact and the heavy impact. The extraction method is based on the impact determination method executed by the airbag ECU 100 of the first embodiment. Thus, a part of the content of the impact determination method is incorporated in the extraction method.

The main controller 201 is a controller that controls processes executed by the data acquisition unit 210, the position determination unit 230, and the impact determination unit 240. The main controller 201 executes processes other than the processes executed by the data acquisition unit 210, the position determination unit 230, and the impact determination unit 240.

The data acquisition unit 210 acquires (reads) data for a time during traveling, a vehicle position, and an acceleration associated with one vehicle ID from the DB 300. The data may be read from the DB 300 in order of the vehicle ID or in order of storage in the DB 300.

The position determination unit 230 determines whether the position data included in the data acquired by the data acquisition unit 210 represents the position where the light impact may be applied, or the position where the heavy impact may be applied.

When the position data represents the position where the light impact may be applied, the impact determination unit 240 determines whether or not the light impact is applied in the vehicle 10 by comparing the acceleration represented by the acceleration data included in the data acquired by the data acquisition unit 210 with the determination threshold used in determination of the light impact. The light impact has the same meaning as the light impact in the first embodiment.

When the position data represents the position where the heavy impact may be applied, the impact determination unit 240 determines whether or not the heavy impact is applied in the vehicle 10 by comparing the acceleration represented by the acceleration data included in the data acquired by the data acquisition unit 210 with the determination threshold used in determination of the heavy impact. The heavy impact has the same meaning as the heavy impact in the first embodiment.

A method of determining the light impact and the heavy impact by the impact determination unit 240 is the same as the method of the impact determination unit 140 of the first embodiment.

The storage controller 250 is the same as the storage controller 150 of the first embodiment. When the impact determination unit 240 determines that the light impact or the heavy impact is applied, the storage controller 250 writes (stores) the time data representing the time of application of the light impact or the heavy impact, the position data representing the position of application of the light impact or the heavy impact, and the acceleration data at the application of the light impact or the heavy impact in association with each other into an impact database stored in the memory 260.

The memory 260 stores an impact determination program that causes a computer to function as the impact data extraction device 200. The memory 260 is a non-transitory recording medium storing data such as a program that can be read by a computer. The memory 260 is implemented using a non-volatile memory. The memory 260 stores the data used in impact determination illustrated in FIG. 2, the data representing the thresholds used in impact determination illustrated in FIG. 4A and FIG. 4B, and the impact database.

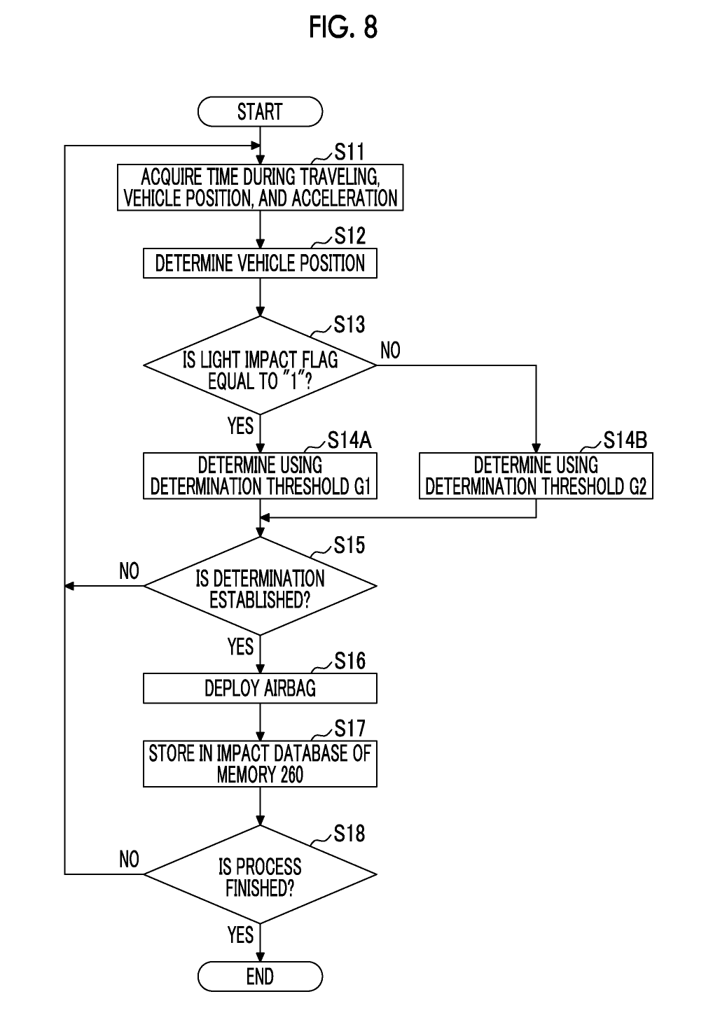

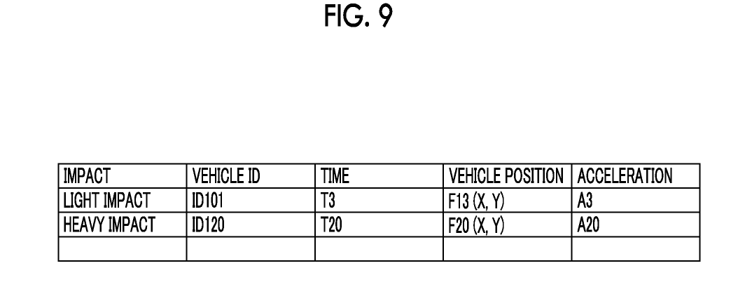

FIG. 8 is a flowchart illustrating a process executed by the impact data extraction device 200. The flow illustrated in FIG. 8 is started when a user of the impact data extraction device 200 operates the impact data extraction device 200 to start the process. FIG. 9 is a diagram illustrating light impact and heavy impact data extracted using the flow illustrated in FIG. 8.

The data acquisition unit 210 acquires data for a time during traveling, a vehicle position, and an acceleration associated with one vehicle ID from the DB 300 (step S11). Accordingly, the vehicle ID, the time data representing a time, the position data representing the current position of the vehicle, and the acceleration data are acquired.

The position determination unit 230 determines whether the position data acquired in step S11 represents the position (an urban area, a parking lot, or the like) where the light impact may be applied, or the position (an expressway, an automobile-only road, or the like) where the heavy impact may be applied (step S12). The determination in step S12 is a process of specifying the current position of the vehicle by determining the latitude and the longitude of any of the identifiers ID001 to ID004 in the data illustrated in FIG. 2 that include the position data in the data acquired in step S11.

The impact determination unit 240 reads the light impact flag associated with the position specified in step S12 from the data in FIG. 2, and determines whether or not the light impact flag is equal to “1” (step S13).

When the impact determination unit 240 determines that the light impact flag is equal to “1” (S13: YES), the impact determination unit 240 uses the determination threshold G1 to determine whether or not the acceleration data in the data acquired in step S11 is higher than or equal to the determination threshold G1 (step S14A).

When the impact determination unit 240 determines that the light impact flag is equal to “0” (S13: NO), the impact determination unit 240 uses the determination threshold G2 to determine whether or not the acceleration data in the data acquired in step S11 is higher than or equal to the determination threshold G2 (step S14B).

When the process of step S14A or S14B is finished, the impact determination unit 240 determines whether or not the determination in step S14A or S14B is established (step S15).

When the impact determination unit 240 determines that the determination is established (S15: YES), the airbag deployment controller 170 deploys the airbag 70 (step S16). The vehicle ID, the time data, the position data, and the acceleration data in the data at the establishment of the determination are stored in the impact database of the memory 260 by the storage controller 250 (step S17). Accordingly, in the data extracted from the DB 300, the vehicle ID, the time data, the position data, and the acceleration data in the data at the application of the light impact can be stored in the impact database of the memory 260. The vehicle ID, the time data, the position data, and the acceleration data in the data at the application of the heavy impact can be stored in the impact database of the memory 260. The impact database may include divided memory regions so that the data of the light impact and the data of the heavy impact can be separately stored.

When the impact determination unit 240 determines that the determination is not established (S15: NO), the main controller 201 causes the flow to return to step S11.

When the process of step S17 is finished, the main controller 201 determines whether or not the process is finished (step S18). For example, the process is finished (END) when the impact data extraction device 200 finishes the process for all data stored in the DB 300. Then, the series of processes is finished.

In step S17, for example, the vehicle ID, the time data, the position data, and the acceleration data in the data at the establishment of the determination are stored in the impact database of the memory 260 in the format illustrated in FIG. 9. In FIG. 9, for the light impact, the vehicle having the vehicle ID of ID101 is associated with time T3, the vehicle position F13(X,Y), and the acceleration A3. For the heavy impact, the vehicle having the vehicle ID of ID120 is associated with time T20 in traveling, the vehicle position F20(X,Y), and the acceleration A20.

As described thus far, the impact data extraction device 200 of the second embodiment reads the time data, the position data, and the acceleration data associated with the vehicle ID from data that is stored in the DB 300 and includes the vehicle ID, the time data, the position data, and the acceleration data in association with each other for various vehicles. The impact data extraction device 200 determines whether or not the light impact or the heavy impact is applied using the different determination threshold G1 or G2 according to whether the position of the vehicle is the position where the light impact may be applied, or the position where the heavy impact may be applied.

Thus, when the position of the vehicle is the position where the light impact may be applied, it is possible to determine whether or not the light impact is applied using the determination threshold G1 for the light impact. When the position of the vehicle is the position where the heavy impact may be applied, it is possible to determine whether or not the heavy impact is applied using the determination threshold G2 for the heavy impact.

Accordingly, when traveling data at the application of the light impact and the heavy impact is extracted from data that is stored in the DB 300 and includes a collection of random traveling data for various vehicles, the impact data extraction method, the impact data extraction device, and the non-transitory storage medium including the impact data extraction program recorded thereon that suppress erroneous determinations and can correctly determine an event accompanying an impact in accordance with the position of the vehicle and the acceleration of the vehicle can be provided.

After the event accompanying the impact is correctly determined, the time data, the position data, and the acceleration data at the application of the light impact, and the time data, the position data, and the acceleration data at the application of the heavy impact can be stored in the database of the memory 260.

Thus, from a large amount of data, the time data, the position data, and the acceleration data when an impact caused by a collision of the vehicle is applied can be stored in the database of the memory 260. A situation where the time data, the position data, and the acceleration data when an impact other than from a collision of the vehicle is applied are erroneously stored in the database of the memory 260 can be suppressed.

While the impact determination method, the impact determination device, the non-transitory storage medium including the impact determination program recorded thereon, the impact data extraction method, the impact data extraction device, and the non-transitory storage medium including the impact data extraction program recorded thereon are described thus far in an illustrative embodiment of the present disclosure, the present disclosure is not limited to the specifically disclosed embodiment. Various modifications or changes can be made to an extent not departing from the claims.

What is claimed is:

1. An impact determination method comprising:
acquiring, by an computer, a vehicle position;
acquiring, by the computer, an acceleration of the vehicle;
determining, by the computer, whether or not an impact is applied to the vehicle by determining the acceleration using a different threshold corresponding to the vehicle position; and
outputting a signal representing a determination..

2. The impact determination method according to claim 1, further comprising determining, by the computer, whether the vehicle position is a first position or a second position,
wherein the determining whether or not the impact is applied to the vehicle includes
determining, by the computer, whether or not the impact is applied to the vehicle by comparing the acceleration with a first determination threshold when a determination that the vehicle position is the first position is made, and
determining, by the computer, whether or not the impact is applied to the vehicle by comparing the acceleration with a second determination threshold higher than the first determination threshold when a determination that the vehicle position is the second position is made.

3. The impact determination method according to claim 1, further comprising executing, by the computer, when a determination that the impact is applied to the vehicle is made, a control to deploy an airbag.

4. The impact determination method according to claim 1, further comprising executing, by the computer, when a determination that the impact is applied to the vehicle is made, a control to record vehicle information including the vehicle position.

5. The impact determination method according to claim 2, wherein the first position is a position where a speed limit of the vehicle is lower than the speed limit of the vehicle at the second position.

6. An impact determination device comprising an electronic control unit configured to:
acquire a vehicle position that is a position of a vehicle;
acquire an acceleration of the vehicle;
determine whether or not an impact is applied to the vehicle by determining the acceleration using a different threshold corresponding to the vehicle position; and
output a signal representing a determination.

7. The impact determination device according to claim 6, wherein the electronic control unit is configured to:
determine whether the vehicle position is a first position or a second position;
determine, when the electronic control unit determines that the vehicle position is the first position, whether or not the impact is applied to the vehicle by comparing the acceleration with a first determination threshold; and
determine, when the electronic control unit determines that the vehicle position is the second position, whether or not the impact is applied to the vehicle by comparing the acceleration with a second determination threshold higher than the first determination threshold.

8. The impact determination device according to claim 6, wherein the electronic control unit is configured to output a signal to execute a control to deploy an airbag when the electronic control unit determines that the impact is applied to the vehicle.

9. The impact determination device according to claim 6, wherein the electronic control unit is configured to output a signal to execute a control to record vehicle information including the vehicle position when the electronic control unit determines that the impact is applied to the vehicle.

10. The impact determination device according to claim 7, wherein the first position is a position where a speed limit of the vehicle is lower than the speed limit of the vehicle at the second position.

11. A non-transitory storage medium on which an impact determination program is recorded, wherein the impact determination program causes an impact determination device to execute
acquiring a vehicle position that is a position of the vehicle,
acquiring an acceleration of the vehicle,
determining whether or not an impact is applied to the vehicle by determining the acceleration using a different threshold corresponding to the vehicle position, and
outputting a signal representing a determination.

12. An impact data extraction method comprising:
acquiring, by an computer, a time, a vehicle position, and an acceleration associated with each other from a database storing the time, a vehicle position that is a position of the vehicle at the time, and the acceleration of the vehicle in the vehicle position in association with each other;
determining, by the computer, whether or not the impact is applied to the vehicle by determining the acceleration using a different threshold corresponding to the vehicle position; and
extracting, by the computer, the acceleration at a time when a determination that the impact is applied to the vehicle is made, and the vehicle position and the time associated with the acceleration from the database.

13. The impact data extraction method according to claim 12, further comprising determining, by the computer, whether the vehicle position is a first position or a second position,
wherein the determining whether or not the impact is applied to the vehicle includes
determining, by the computer, whether or not the impact is applied to the vehicle by comparing the acceleration with a first determination threshold when a determination that the vehicle position is the first position is made, and
determining, by the computer, whether or not the impact is applied to the vehicle by comparing the acceleration with a second determination threshold higher than the first determination threshold when a determination that the vehicle position is the second position is made.

14. The impact data extraction method according to claim 12, further comprising executing, by the computer, when a determination that the impact is applied to the vehicle is made, a control to deploy an airbag.

15. The impact data extraction method according to claim 12, further comprising executing, by the computer, when a determination that the impact is applied to the vehicle is made, a control to record vehicle information including the vehicle position.

16. The impact data extraction method according to claim 13, wherein the first position is a position where a speed limit of the vehicle is lower than the speed limit of the vehicle at the second position.

17. An impact data extraction device comprising:
a database storing a time, a vehicle position that is a position of the vehicle at the time, and an acceleration of the vehicle in the vehicle position in association with each other; and
an electronic control unit configured to:
acquire the time, the vehicle position, and the acceleration associated with each other from the database, determine whether or not an impact is applied to the vehicle by determining the acceleration using a different threshold corresponding to the vehicle position, and extract and output the acceleration at a time when the electronic control unit determines that the impact is applied to the vehicle, and the vehicle position and the time associated with the acceleration from the database.

18. The impact data extraction device according to claim 17, wherein the electronic control unit is configured to:
determine whether the vehicle position is a first position or a second position;
determine, when the position determination unit determines that the vehicle position is the first position, whether or not the impact is applied to the vehicle by comparing the acceleration with a first determination threshold; and
determine, when the position determination unit determines that the vehicle position is the second position, whether or not the impact is applied to the vehicle by comparing the acceleration with a second determination threshold higher than the first determination threshold.

19. The impact data extraction device according to claim 17, wherein the electronic control unit is configured to output a signal to execute a control to deploy an airbag when the electronic control unit determines that the impact is applied to the vehicle.

20. The impact data extraction device according to claim 17, wherein the electronic control unit is configured to output a signal to execute a control to record vehicle information including the vehicle position when the electronic control unit determines that the impact is applied to the vehicle.

21. The impact data extraction device according to claim 18, wherein the first position is a position where a speed limit of the vehicle is lower than the speed limit of the vehicle at the second position.

22. A non-transitory storage medium on which an impact data extraction program is recorded, the impact data extraction program causing a computer to extract data representing whether or not an impact is applied to a vehicle, wherein the impact data extraction program causes the computer to execute
acquiring a time, a vehicle position, and an acceleration associated with each other from a database storing the time, the vehicle position that is a position of the vehicle at the time, and the acceleration of the vehicle in the vehicle position in association with each other,
determining whether or not the impact is applied to the vehicle by determining the acceleration using a different threshold corresponding to the vehicle position acquired in the acquiring, and
extracting and outputting the acceleration at a time when a determination that the impact is applied to the vehicle is made in the determining of the impact, and the vehicle position and the time associated with the acceleration from the database.
